(19) United States
(12) Patent Application Publication
(10) Pub. No.: US 2008/0279078 A1
(43) Pub. Date: Nov. 13, 2008

(54) Split Disc Optical Storage Medium and Device

(75) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/599,990

(22) PCT Filed: Apr. 13, 2005
(86) PCT No.: PCT/IB05/51211

§ 371 Date: Oct. 17, 2006

(30) Foreign Application Priority Data
Apr. 20, 2004 (EP) 04101621.3

(51) Int. Cl. G11B 3/74

(52) U.S. Cl. 369/94

(57) ABSTRACT

Optical data storage medium comprising a first disc (11) and a second disc (12) both having an access surface (16) and a storage layer covered by the access surface, wherein the storage layer is adapted to be accessed by a laser beam via the access surface, characterized in that the first disc and the second disc are adapted to be attached to each other in such a way, that the access surface of the first disc covers the access surface of the second disc. Further a device for reproducing information from or recording information into at least one storage layer of such an optical data storage medium.

The present invention relates to an optical storage medium and a device for reproducing information from or recording information into such an optical data storage medium. Optical storage media such as CDs (compact discs), DVDs (digital versatile discs) and BDs (blue ray discs) employ a simple disc structure. The discs consist of one or more layers of reflective material. Lands, grooves and/or pits are embedded in the material for storing data. The storage layer is covered by a protective layer. The reflective storage layers can be written to and read using a laser beam. In order to improve the storage capacity of the media, laser sources emitting laser beams with decreasing wavelengths λ are being used by new generation technologies. These beams are focused to an optical spot by means of an objective lens having a numerical aperture (NA), which value is increased for new generation technologies. The optical spot diameter is proportional to λ/NA. A reduced wavelength and an increasing NA requires reduction of the thickness of the protective layers from 1.2 mm for CDs, to 0.6 mm for DVDs, and finally to 0.1 mm for BDs. For future technologies an even thinner protective layer may be necessary. Consequently, the risk of damaging: the storage layer increases, if the thickness of the protective layers decreases. The protective layers covering the surface must be very hard in order to avoid physical damages due to scratches and deposits on the surface of the optical storage discs. This problem could limit the future development of optical storage media.

Therefore, it is an object of the present invention to propose an optical storage medium, which solves the above-mentioned problem.

It is a further object of the present invention to propose a device for reproducing information from or recording information into such an optical data storage medium.

This first object has been achieved in accordance with the invention by an optical storage medium comprising a first disc and a second disc. Both discs have an access surface and a storage layer covered by the access surface. The storage layer is adapted to be accessed by a laser beam via the access surface. The first disc and the second disc are adapted to be attached to each other in such a way, that the access surface of the first disc covers the access surface of the second disc. The configuration of the information-carrying medium is changed from a single disc to a “double split disc configuration”. The storage medium consists of two parts; both are discs, which can be physically coupled together for transportation and storage. Hence, the concept is called “split disc”. The access surfaces of the discs consist of protective layers. The storage layer is positioned beneath the access surfaces. The inner layers of the discs contain the information carrying layers. The depth of the information carrying layers under the access surface may be small in order: to allow a high frequency laser to be used for accessing the information storing layers. However, placing the information on the inside of the first and second discs attached to each other, the risk of damage is effectively removed. The access surfaces of the first and second discs and consequently the storage layers are not subjected to scratches and deposits. Note that the term disc is not meant to limit the shape of the medium to a circular shape. Any other shape, e.g. rectangular, square, triangular etc. may be used without departing from the spirit of the invention.

Preferably, the first disc has a cavity in the access surface adapted to receive the access surface of the second disc. The cavity of the first disc may have an edge corresponding to an edge of the access surface of the second disc. The edge of the cavity of the first disc and the edge of the access surface of the second disc may both constitute circles having substantially the same diameter. The diameter of the first disc is slightly larger than the diameter of the second disc. Therefore, the access surface of the second disc may be positioned within the cavity of the first disc. The cavity or depression of the first disc has a depth approximating to a percentage, e.g. 1-50%, of the thickness of the second disk. Both access surfaces are protected from environmental influences in this position. The first and second disc are fixed in such a way relative to each other, that they may only be moved in a direction perpendicular to the access surfaces. The access surfaces of the discs are sealed from damage from dust, fluids or particles.

Preferably, the first disc comprises a column perpendicularly protruding from the access surface of the first disc. The second disc having a surface opposite to its access surface has a hole for receiving said column of the first disc. Preferably, the hole extends from the access surface to the opposite surface of the second disc. The first and the second discs may be fixed relative to each other by positioning the column in the hole. The column is adapted to pass through the hole. Preferably, a cross section of the column corresponds to a cross section of the hole. Therefore, the column fits exactly into the hole such that the first and the second discs are tightly secured to each other. In this state the column preferably protrudes from the opposite surface of the second disc. A lock may be attached to the part of the column protruding from the opposite surface in order to fasten a first disc to the second disc.

The further object has been achieved by a device for reproducing information from or recording information into at least one storage layer of an optical data storage medium as described above, comprising

means for inserting at least one of the first disc and the second disc into the device,

means for positioning and rotating at least one of said first disc and said second disc such that the at least one storage layer is readable by the laser beam.

In an embodiment the device additionally comprises

means for separating the first disc and the second disc from each other. This has the advantage that the user does not have to take the first disc and the second disc apart manually. This further reduces the probability of damage to the access surfaces.

Preferred embodiments of the present invention are described with reference to the accompanied drawings.

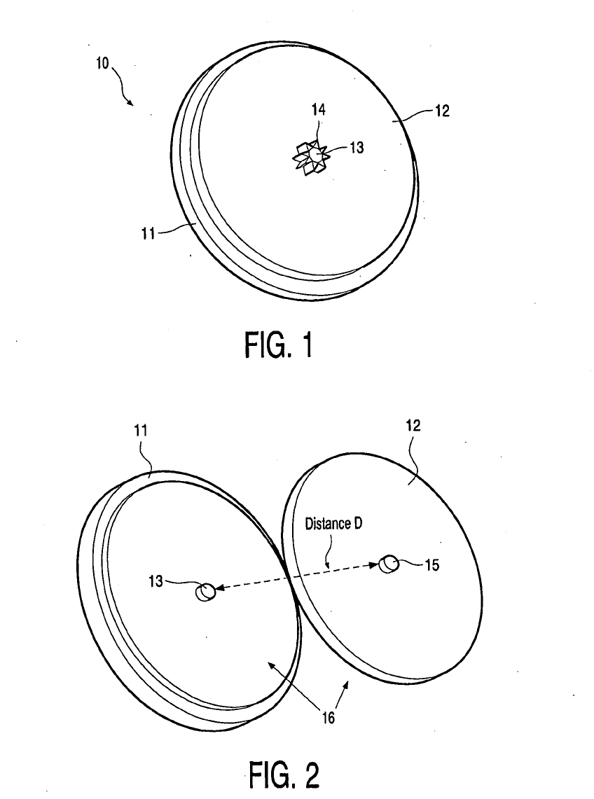

FIG. 1 shows an optical storage medium according to a first preferred embodiment of the present invention in a locked state.

FIG. 2 shows the first embodiment of the present invention in an unlocked state.

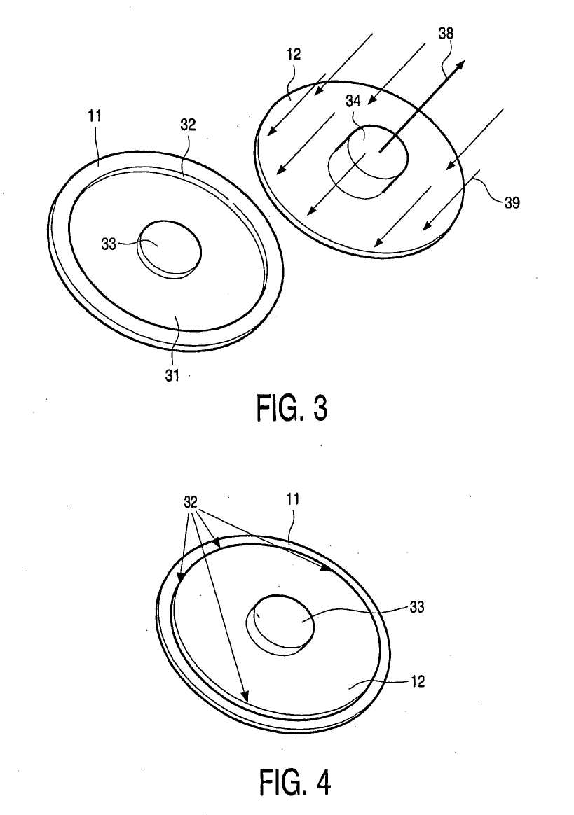

FIG. 3 shows a second embodiment of the present invention in an unlocked state.

FIG. 4 shows the second embodiment of the present invention in a locked state.

The optical data storage medium 10 shown in FIG. 1 comprises a first disc 11, a second disc 12 and a lock 14. A column 13 protrudes from the first disc 11. The lock 14, secured to said column 13, performs a friction grip on said column 13. The lock 14 consists of plural latches or spring clips positioned radially around the column. Both discs, the first disc 11 as well as the second disc 12, have a circular shape. The diameter of the discs is considerably larger than its thickness.

FIG. 2 shows the first disc 11 and second disc 12 separated from each other. The second disc 12 includes a hole 15 and the first disc includes a column 13. Hole 15 and column 13 are both positioned at the centre of both discs. The column 13 at the centre of the first disc 11 may be inserted through the hole 15 in the second disc 12. The lock 14 shown in FIG. 1 may be provided with the column 13 of the first disc 11. The lock mechanism may be easily opened by the appropriate device in the disc player, which allows the two discs to be separated and driven. The discs may be driven from separate hubs or remain coupled to be driven in a coupled fashion.

When split, the discs will be removed by a distance D. This distance will be large enough to allow access to the discs inner surfaces constituting the access surfaces 16 of the discs. A laser beam is used to read the information on the one or both surfaces 16 simultaneously.

Once the information on the discs has been extracted or inserted, the two discs may be reunited and the column lock mechanism is used to attach the two discs together. New labelling information can be written on the backside of the outer surfaces, opposite from the access surfaces, of the discs.

The second embodiment of the present invention is depicted in FIGS. 3 and 4. The optical data storage medium according to the second embodiment comprises two discs, a first disc 11 and a second disc 12. The first disc has a circular shape. A column 33 is provided at the centre of the first disc 11. The column 33 protrudes from the access surface of the first disc 11. Furthermore, a cavity, formed by a recessed surface 31 and a side wall 32, is provided in the access surface of the first disk 11. The edge of the cavity is circular. The edge of the second disc 12 also has a circular shape. The second disc 12 comprises a second centre column 34 protruding in a direction opposite to the access surface of the second disc 12. The diameter of the second disc 12 precisely corresponds to the diameter of the cavity of the first disc 11; the diameter of the first disc 11 is slightly larger. The edge of the second disc and the inner side wall of the cavity of the first disc 11 should be profiled with a rounded camber in such a way that they form a lock. The lock is devised to facilitate the mechanical coupling and decoupling of the two discs, yet it allows the detection of the history of such decouplings by features in the mechanical form of the profile.

Several arrows are shown in FIG. 3. They depict forces applied to the second disc 12. The centre force indicated by arrow 38 is applied to the second disc 12 in a direction opposite to the access surface of the second disc 12. Furthermore, a force is applied to the periphery of the second disc 12, indicated by arrows 39. The centre force and peripheral force acting on the second disc 12 deform the second disc slightly. The circumference of the second disc 12 is bent slightly downwards in a direction opposite to the centre force 38. Consequently, the diameter of the circumference of the second disc 12 is reduced. In this position the second disc may be inserted into the cavity of the first disc 11. FIG. 4 shows the second disc 12 inserted into the cavity of the first disc. 11 If the centre and peripheral forces are no longer applied to the second disc 12, the deformation of the second disc 12 is reversed, since the disc was deformed elastically. The diameter of the second disc increases, such that the circumference of the second disk is pressed against the side wall of the cavity of the first disc 11. A tight connection is obtained due to the friction between said boundary and said circumference.

A device (not drawn) for reproducing information from or recording information into at least one storage layer of an optical data storage medium as described above, comprises means for inserting at least one of the first disc and the second disc into the device and means for positioning and rotating at least one of said first disc and said second disc such that the at least one storage layer is readable by the laser beam.

The device additionally comprises means for separating the first disc and the second disc from each other. This has the advantage that the user does not have to take the first disc and the second disc apart manually. This further reduces the probability of damage to the access surfaces.

1. Optical data storage medium (10) comprising
a first disc (11) and a second disc (12) both having an access surface (16) and a storage layer covered by the access surface, wherein the storage layer is adapted to be accessed by a laser beam via the access surface,
characterized in that the first disc and the second disc are adapted to be attached to each other in such a way, that the access surface of the first disc covers the access surface of the second disc.

2. Optical data storage medium according to claim 1, wherein the first disc has a cavity in the access surface adapted to receive the access surface of the second disc.

3. Optical data storage medium according to claim 2, wherein the cavity of the first disc has an edge corresponding to an edge of the access surface of the second disc.

4. Optical data storage medium according to claim 3, wherein the edge of the cavity of the first disc and the edge of the access surface of the second disc both constitute circles having the same diameter.

5. Optical data storage medium according to claim 1, wherein the first disc comprises a column perpendicularly protruding from the access surface of the first disc and wherein the second disc comprises a surface opposite to the access surface and a hole for receiving said column, said hole extending from the access surface to the opposite surface of the second disc.

6. Optical data storage medium according to claim 5, wherein a cross section of said column corresponds to a cross section of said hole.

7. Optical data storage medium according to claim 6, wherein the cross section of said column and said hole both constitute circles having the same diameter.

8. Optical data storage medium according to claim 5, wherein said column is adapted to protrude from the opposite surface of the second disc, when said column is inserted in said hole.

9. Optical data storage medium according to claim 6, comprising a lock adapted to being attached to the part of the column protruding from the opposite surface of the second disc in order to fasten the first disc to the second disc.

10. First disc or second disc as defined in claim 1.

11. Device for reproducing information from or recording information into at least one storage layer of an optical data storage medium according to claim 1, comprising
means for inserting at least one of the first disc and the second disc into the device,
means for positioning and rotating at least one of said first disc and said second disc such that the at least one storage layer is readable by the laser beam.

12. Device according to claim 11, additionally comprising
means for separating the first disc and the second disc from each other.
